(19) United States
(12) Patent Application Publication
(10) Pub. No.: US 2012/0265627 A1
(43) Pub. Date: Oct. 18, 2012

(54) SYSTEM AND METHOD FOR ENABLING POINT OF SALE FUNCTIONALITY IN A WIRELESS COMMUNICATIONS DEVICE

(75) Inventors: Jonathan Otto, Palm Beach, FL (US); Andrew Van Luchene, Santa Fe, NM (US); Raymond J. Mueller, (US); Michael R. Mueller, San Francisco, CA (US)

(73) Assignee: RETAILDNA, LLC, Palm Beach, FL (US)

(21) Appl. No.: 13/527,884

(22) Filed: Jun. 20, 2012

Related U.S. Application Data
(62) Division of application No. 12/008,428, filed on Jan. 11, 2008.

(51) Int. Cl. G06Q 20/20; G06Q 20/32

(52) U.S. Cl. 705/21

(57) ABSTRACT

The invention broadly comprises a method for enabling point of sales (POS) functionality in a wireless communications device (WCD) including the steps of: transmitting, using an interface element in at least one specially programmed general purpose computer, a POS function control signal to a communication network for transmission to a WCD, the WCD located in a retail location; activating a POS function, in response to the control signal, to enable POS functionality in the WCD, the POS function stored in a memory element for the WCD or in a memory element for the at least one specially programmed computer; acquiring, using the POS function, an identification of an item via the WCD; receiving, using the interface element, the identification data for the item from the WCD via the communication network; and generating, using a processor for the at least one general-purpose computer, an order including the first item.

### CROSS-REFERENCE TO RELATED APPLICATIONS

This application claims benefit and priority to, and is a Divisional of, U.S. patent application Ser. No. 12/008,428 filed on Jan. 11, 2008 and titled “SYSTEM AND METHOD FOR ENABLING POINT OF SALE FUNCTIONALITY IN A WIRELESS COMMUNICATIONS DEVICE”, the entirety of which is hereby incorporated by reference herein.

This application is also “related to”: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)”0 and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to methods and systems for enhancing the usability of a wireless communication device (WCD) in a retail environment. In particular, the invention relates to methods and systems for enabling point of sale functionality in a WCD.

### BACKGROUND OF THE INVENTION

It is known to use a wireless communications device (WCD) to connect to on-line or other virtual retail environments. Unfortunately, such functionality is not available in “brick and mortar” or non-virtual retail environments.

Thus, there is a long-felt need to provide a system and method to enable a WCD to function in sales and other transactions in a retail location.

### SUMMARY OF THE INVENTION

The invention broadly comprises a method for enabling point of sales (POS) functionality in a wireless communications device (WCD) including the steps of: transmitting, using an interface element in at least one specially programmed general purpose computer, a POS function control signal to a communication network for transmission to a WCD, the WCD located in a retail location; activating a POS function, in response to the control signal, to enable POS functionality in the WCD, the POS function stored in a memory element for the WCD or in a memory element for the at least one specially programmed computer; acquiring, using the POS function, an identification of a first item via the WCD; receiving, using the interface element, the identification data for the first item from the WCD via the communication network; generating, using a processor for the at least one general-purpose computer, an order including the first item; and storing the order in the memory element for the at least one general-purpose computer.

In a preferred embodiment a step receives, using the interface element, a request, from the WCD via the communication network, to initiate the POS function in the WCD; another step identifies, using the processor, the WCD or an end user of the WCD; and a further step generates, using the processor, the control signal response to the identification of the WCD or the end user.

In a first embodiment, the WCD supplied to the end user upon entry of the end user into the retail location or upon the end user reaching a certain proximity of the retail location. Then, a first step acquires, using the WCD, identification data regarding an end user of the WCD; a second step receives, using the interface element, the identification data regarding the end user from the WCD via the communication network; and a third step determines, using the processor, whether the end user is authorized. Then, generating and transmitting the control signal to the communication network for transmission to the WCD includes generating and transmitting in response to a determination that the user is authorized.

In a second embodiment, a first step determines, using the interface element and the processor, that the WCD is located in the retail location or within a specified proximity of the retail location; a second step generates, using the processor, a query regarding initiation of the POS function in the WCD; a third step transmits, using the interface element, the query to the communication network for transmission to the WCD; a fourth step receives, using the interface element, a request, from the WCD via the communication network, to initiate the POS function in the WCD; and a fifth step generates, using the processor, the control signal responsive to the request.

In a third embodiment, the WCD supplied to an end user upon entry of the end user into the retail location or upon the end user reaching a certain proximity of the retail location. Then, a first step generates, using the processor, a query regarding initiation of the POS function in the WCD; a second step transmits, using the interface element, the query to the communication network for transmission to the WCD; a third step receives, using the interface element, a first request, from the WCD via the communication network, to initiate the POS function in the WCD; a fourth step generates, using the processor, the control signal response to the first request; a fifth step generates, using the processor, a second request to provide information regarding the end user; a sixth step transmits, using the interface element, the second request to the communication network for transmission to the WCD; a seventh step acquires, using the WCD, information regarding the end user; an eighth step receives, using the interface element, the information from the WCD via the communication network; and a ninth step determines, using the processor, whether the user is authorized and wherein generating the control signal includes generating in response to a determination that the user is authorized.

In a fourth embodiment, a step connects the WCD with a docking station and another step transceives communications between the interface element and the WCD through the docking station. In a preferred embodiment, a first step receives, in the interface element, a first request from the WCD, via the communication network, to initiate payment for the order; a second step generates, in the processor, a second request to select or authorize a payment option for the order; a third step transmits, using the interface element, the second request to the communication network for transmission to the WCD; and a fourth step receives, in the interface element, a selection or authorization for a payment option from the WCD, via the communication network. In one embodiment, a step generates, using the processor, a confirmation that the order has been paid for; another step transmits, using the interface element, the confirmation to a station in the retail location; a further step provides the confirmation, at the station, for use in checking items in possession of an end user of the WCD with items in the order; and yet another step generates an authorization, using the processor, that the items in possession of the end user correlate with the items in the order.

In a fifth embodiment, a first step adjusts, using the processor, an inventory for the retail location to account for the items in the order. In a sixth embodiment, a second step generates, using the processor, a marketing offer; and another step transmits, using the interface element, the marketing offer to the communication network for transmission to the WCD. In a seventh embodiment, a step identifies, using the processor, the WCD or the end user of the WCD and generating and transmitting the marketing offer include generating and transmitting the marketing offer in response to the identification of the first item, a location of the WCD in the retail location, or an identification of the WCD or the end user.

In an eighth embodiment, a step acquires, using the POS function, an identification of a second item via the WCD, the second item included in the order; another step receives, using the interface element, the identification of the second item from the WCD via the communication network; and a further step deletes, using the processor, the second item from the order. In a preferred embodiment, a step engages a WCD function in the WCD while the POS function is initiated; and another step suppresses, using the processor in the at least one general purpose computer or a processor in the WCD, the WCD function or the POS function.

In a ninth embodiment, a first step acquires, using the POS function, an identification of a third item via the WCD, the second item included in the order; a second step receives, using the interface element, the identification data for the third item from the WCD via the communication network; a third step generates, using the processor, marketing information for the third item; and a fourth step transmits, using the interface element, the marketing information for the third item to the communication network for transmission to the WCD.

The invention broadly comprises a system for enabling POS functionality in a WCD.

It is a general object of the present invention to provide systems and methods to enhance operation of a WCD in a retail location.

It is another object of the present invention to provide systems and methods to enable POS functionality in a WCD.

These and other objects and advantages of the present invention will be readily appreciable from the following description of preferred embodiments of the invention and from the accompanying drawings and claims

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for enabling point of sales (POS) functionality in a wireless communications device (WCD); and,

FIG. 2 is a flow chart of a present invention method for enabling point of sales (POS) functionality in a wireless communications device (WCD).

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Dilution×includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display×includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Location—means and includes, but is not limited to retail stores, restaurants, bars, theme parks, casinos, video game parlors, Internet Cafe's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Network Device—includes any device that can be interfaced with a technology network, for example, the Internet, a wireless communications network, (e.g., a cellular telephone system), a LAN, or a WAN.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

Product—includes any machine, manufacture and/or composition of matter, unless expressly specified otherwise.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Upsell—includes any offer to purchase one or more items at a full, discounted or other price including the retail price. Upsells include offers to increase an order size, quantity, type or contents of an entity's, e.g., a customer's order.

User—includes any entity or person including a person making use or practicing the various disclosed embodiments of the invention. The terms user and end user shall include corollary meanings.

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext.

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®Pentium®or Centrino™processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™by IGT, OASIS™by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

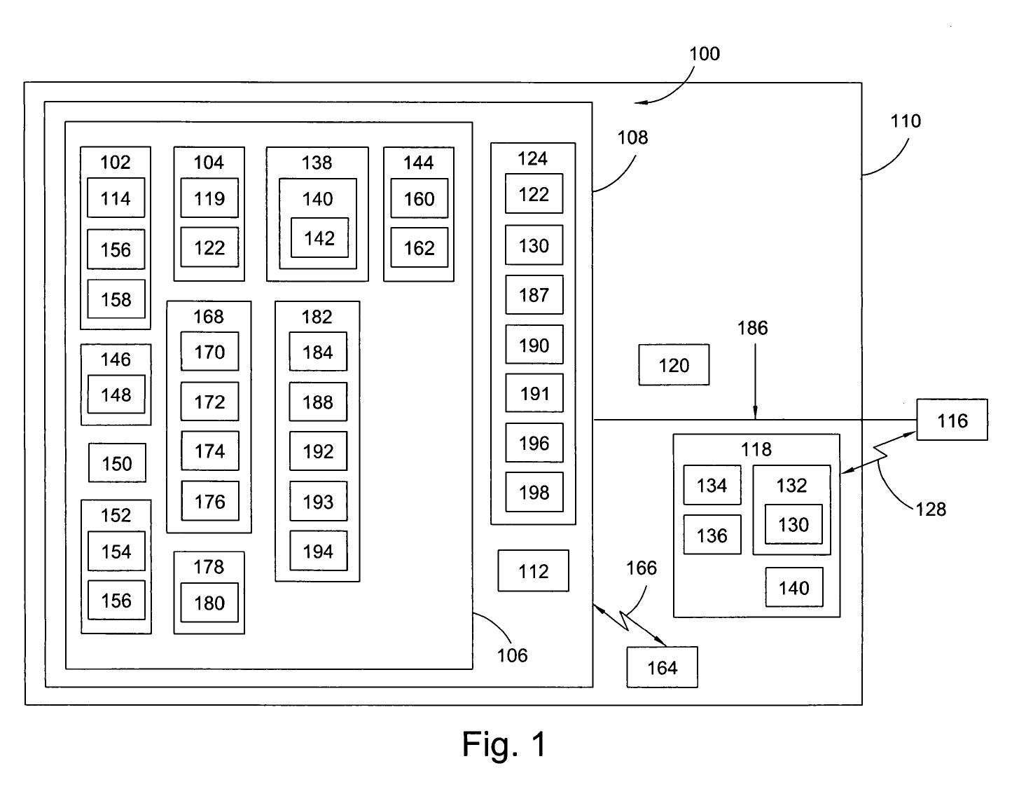

FIG. 1 is a schematic block diagram of present invention system 100 for enabling point of sales (POS) functionality in a wireless communications device (WCD). System 100 includes control signal element, or function, 102, and order element, or function, 104, each in processor 106 of at least one specially programmed general-purpose computer 108. Alternately stated, elements 102 and 104 and any other elements described as being in the processor are functions of the processor or are functions carried out by the processor, for example, in response to the special programming.

Computer 108 can be any computer or plurality of computers known in the art. In one embodiment, the computer is located in a retail location with which system 100 is associated, for example, location 110. In another embodiment (not shown), all or parts of the computer are remote from retail locations with which the operations of system 100 are associated. In a further embodiment, computer 108 is associated with a plurality of retail locations with which system 100 is associated. Thus, the computer provides the functionality described for more than one retail location.

Element 102 is arranged to generate and transmit, via interface element 112 of the general-purpose computer, POS function control signal 114 to communication network 116 for transmission to WCD 118 located in or within a specified proximity of retail location 110. The order element is arranged to receive, using the interface element, identification data 119 regarding item 120 from the WCD via the communication network and to generate, using data 119, order 122, including item 120. Computer 108 also includes memory element 124 arranged to store the order.

By interface element, we mean any combination of hardware, firmware, or software in a computer used to enable communication or data transfer between the computer and a device, system, or network external to the computer. The interface element can connect with the device, system, or network external to the computer, for example, network 116, using any means known in the art, including, but not limited to a hardwire connection, an optical connection, an Internet connection, or a radio frequency connection. In the figures, a non-limiting example of a hardwire connection 126 is shown. Processor 106 and interface element 112 can be any processor or interface element, respectively, or combination thereof, known in the art.

A WCD is defined supra. WCD 118 can be any WCD known in the art. In one embodiment, WCD 118 is owned by, leased by, or otherwise already in possession of an end user when system 100 interfaces with the WCD. In the description that follows, it is assumed that the WCD is owned by, leased by, or otherwise already in possession of the end user when system 100 interfaces with the WCD unless stated otherwise. In general, the WCD communicates with a network, for example, network 116, via radio-frequency connection 128. Network 116 can be any network known in the art. In one embodiment, the network is located outside of the retail location, for example, the network is a commercial cellular telephone network. In one embodiment (not shown), the network is located in a retail location, for example, the network is a local network, such as a Bluetooth network.

POS application, or function, 130 is stored in one or both of memory element 124 or memory element, or combination of processor and memory element, 132 in the WCD, as described infra. The POS application enables POS functionality in the WCD, for example, in response to receipt of the control signal by the WCD. That is, the POS function is activated by the receipt of the control signal. As described supra, a POS function is an application that enables the generating, transmission, and processing of an order to purchase one or more items. For example, in response to the control signal, the WCD is enabled to perform the POS functions described infra, for example, acquiring data to identify items, generating orders, and paying for orders. The POS function can be configured in at least the following arrangements:

1. The POS function/application is pre-loaded in processor, memory element, or combination of processor and memory element, 132. The application is then activated by the control signal.

2. The POS function/application is partially pre-loaded in element 132 and fully or partially stored in memory 124. This is the arrangement shown in the figures. In this case, the control signal includes the additional code from the application in memory element 124 necessary to enable the POS function in the WCD.

3. The POS function/application is stored in element 124 and included in the control signal for downloading by the WCD.

4. The POS function/application is stored in element 124 and applicable instructions etc. are transmitted to the WCD to enable the POS function in the WCD. That is, the WCD is substantially a slave device

It should be understood that system 100 is not limited to the arrangements noted above and that other arrangements are included in the spirit and scope of the claimed invention.

POS functionality includes enabling the WCD to acquire identification data one or more items in location 110. For example, the WCD also is arranged to acquire identification data 119 using any means known in the art. For example, the data can be acquired by camera 134 built into the device that takes pictures of barcodes or other identifying indicia on item 120 and converts the picture into the identification data. In one embodiment, an end user can input data regarding the item using GUI 136, for example, using a keypad, and the WCD converts the input into the identification.

In one embodiment, system 100 also includes request element 138, in processor 106, arranged to receive, using the interface element, request 140, from the WCD via the communication network, to initiate the POS function in the WCD. The WCD can initiate the transmission of the request using any means known in the art. In one embodiment, the WCD initiates and transmits the request automatically based on location or position information for the WCD and/or location 110. For example, the WCD determines that the WCD is located in location 110 and transmits the request. In a further embodiment, an end user uses GUI 136 to input a command to transmit the request. In general, the request includes identification information 142 regarding the identification of the WCD or an end user of the WCD. The identification information can be embedded in memory aspect 132 or can be inputted to the WCD using GUI 136.

For the embodiments with element 138, system 100 includes identification element 144, in processor 106, arranged to identify the WCD or a first end user of the WCD, for example, using information 142. Then, the control signal element is arranged to generate and transmit the POS control signal in response to the identification of the WCD or the end user by element 144.

In one embodiment, an entity (not shown) operating or owning the retail location supplies the WCD to an end user of the WCD upon entry of the end user into the retail location or upon the end user reaching a certain proximity (not shown) of the retail location. In this embodiment, system 100 includes authorization element 146, in processor 106, arranged to receive from the WCD via network 116, using the interface element, identification data 148 of the end user. Identification data 148 is acquired and transmitted by the WCD using any means known in the art. In another embodiment, the end user swipes or otherwise uses a card (not shown) with the WCD to impart identification data encoded on the card to the WCD. In a further embodiment, identification information can be inputted to the WCD using GUI 136. Element 146 determines whether the user is authorized, for example, based on the identification data. Then, element 102 is arranged to generate and transmit the control signal in response to a determination by element 146 that the user is authorized.

In one embodiment, system 100 includes location element 150 and query element 152, in processor 106. The location element is arranged to determine, using the interface element, that the WCD is located in the retail location or within a specified proximity of the retail location. The query element is arranged to generate query 154 regarding initiation of the POS function in the WCD and to transmit, using the interface element, query 154 to the WCD via network 116. That is, system 100 automatically contacts the WCD to present an inquiry or offer to initiate the POS function in the WCD. In another embodiment, location element determines whether the WCD is authorized or configured to receive/initiate the POS function and only sends query 154 to the WCD if the WCD is authorized or configured to receive/initiate the POS function.

The control signal element is arranged to receive, using the interface element, request 156, from the WCD via the communication network, to initiate the POS function in the WCD, for example, in response to query 154. The request is generated and transmitted by the WCD using any means known in the art. In one embodiment, the WCD automatically generates and transmits the request upon receipt of query 154. In another embodiment, an end user inputs a command to generate and transmit the request using GUI 136, for example, in response to a prompt displayed on the GUI in response to query 154. The control signal element generates and transmits the POS control signal responsive to the request.

In a first embodiment, the WCD is supplied by an entity (not shown) operating or owning the retail location to an end user of the WCD upon entry of the end user into the retail location or upon the end user reaching a certain proximity of the retail location. In this embodiment, query element 152 is arranged to generate query 156 regarding initiation of the POS function in the WCD and to transmit, using the interface element, the query to the communication network for transmission to the WCD. The control signal element is arranged to receive, using the interface element, request 158, from the WCD via the communication network, to initiate the POS function in the WCD and to generate and transmit the POS control signal response to request 158. The WCD can generate and transmit request 158 using any means known in the art, for example, in response to input from the end user via GUI 136.

In a second embodiment, identification element 144 is arranged to generate request 160 to provide information regarding the end user; to transmit, using the interface element, request 160 to the communication network for transmission to the WCD; to receive, using the interface element, information 162 regarding the end user, the information acquired by the WCD and transmitted via the communication network; and to determine, using information 162, whether the user is authorized. The control signal element is arranged to generate and transmit the control signal in response to a determination by element 144 that the user is authorized. Information 162 is acquired and transmitted by the WCD using any means known in the art. In another embodiment, the end user swipes or otherwise uses a card (not shown) with the WCD to impart identification data encoded on the card to the WCD. In a further embodiment, identification information can be inputted to the WCD using GUI 136.

In a third embodiment, system 100 includes docking station 164 arranged for connection to the WCD and arranged to transceive (transmit and receive), using the interface element, communications between processor 106 and the WCD. That is, when the device is connected to the docking station, a link is established or the link is extended or continued between the device and system 100. The docking element can connect with element 112 using any means known in the art, including, but not limited to a hardwire connection, an optical connection, an Internet connection, or a radio frequency connection. In the figures, a non-limiting example of a radio frequency connection 166 is shown. In one embodiment, the docking station is mobile. In another embodiment, the docking station is mobile and is connected to a shopping cart, shopping basket, or other device for holding and transporting items (not shown).

In a preferred embodiment, system 100 includes payment element 168, in processor 106, arranged to receive, via the interface element, a request 170 from the WCD, via the communication network, to initiate payment for order 122; to generate request 172 to select or authorize a payment option for the order; to transmit, using the interface element, request 172 to the communication network for transmission to the WCD; and receive, through the interface element, selection or authorization 174 for a payment option from the WCD, via the communication network. Element 168 is arranged to act on payment information included in authorization 174.

Apparatus 100 can interact with payment systems (not shown) for business location 110 by any means known in the art. In a first embodiment, all payment operations for the location are incorporated in apparatus 100, for example, element 168 and apparatus 100 is able to conduct the payment operations independently. In a second embodiment, some of the payment operations for the location are incorporated in apparatus 100, some of the operations are conducted in a separate system for the business location (not shown), and apparatus 100 interfaces with the separate system to conduct the payment operations. Any reconciliation/payment method known in the art can be used to transfer funds between system 100 and the separate system/business entity operating the location as necessary. In a third embodiment, the payment operations for the location are separate from apparatus 100 and apparatus 100 acts as a conduit for those operations. That is, apparatus 100 interfaces with the operations conducting the payment operations as needed to facilitate the transfer of data etc.

The method of payment used with system 100 can be any payment method known in the art and compatible with wireless communications. For example, the payment can be using a credit card or can be an account associated with the wireless device. For example, when the WCD is a cellular telephone system, the payment can be applied to the cellular telephone system account for the WCD or other payment method associated with such cellular telephone system and/or, as provided by an existing or provided customer account, which may be stored along with other customer or system information. In another embodiment, when an end user has agreed to provide payment methods, for example, by opting into a loyalty or other marketing program and/or by agreement with a cell phone or other network provider, the end user can authorize payment for the item as part of authorization 174. In some aspects, payment alternatives include digital wallets such as those provided by Paypal, Google, and Amazon.

In one embodiment, the payment element also is arranged to generate confirmation 176 that the order has been paid for and to transmit, using the interface element, the confirmation to station 178 in the retail location. The confirmation includes a listing of items in the order. The station is used to provide confirmation 176 to retail location personnel at the station for use in checking items in possession of an end user of the WCD with items in order 122. The personnel use the station to generate, using processor 106, authorization 180 that the items in possession of the end user correlate with the items in the order. The confirmation can be made accessible at the station using any means known in the art. For example, the confirmation can be displayed on a GUI for the station and/or printed at printer for the station. In one embodiment, a store employee uses the list in the confirmation to verify order 122 and enters an approval code, using the station, to initiate generation of the authorization. When the approval code is received, the order is processed and flagged as complete.

In one embodiment, the order element is arranged to adjust an inventory for the retail location to account for the items in the order. For example, if order 122 includes one of item ‘x’ and two of item ‘y,’ the inventory for items in location 110 is adjusted to show the removal of items ‘x’ and ‘y’ from inventory. The order element can be interfaced with an inventory system for the retail location using any means known in the art.

In another embodiment, system 100 includes marketing element 182, in processor 106, arranged to generate marketing offer 184 and to transmit, using the interface element, the marketing offer to the communication network for transmission to the WCD. In a further embodiment, the marketing element is arranged to identify the WCD or the end user of the WCD, for example through data 148, and to generate and transmit the marketing offer in response to the identification of item 120, location 186 of the WCD in the retail location, or the identity of the WCD or the end user. That is, the offer can be made to complement one or more items already in the order, the offer can be made with respect to items in the retail location in the vicinity of the WCD, or the offer can be tailored to the end user, for example, in a further embodiment, element 184 has access to a history 187 of purchases made by the end user and the offer is generated responsive to that history. History 187 can be in memory 124 or can be accessed by system 100 from a separate computer system (not shown).

In one embodiment, the offer element is arranged to generate the offer using at least one executable 188 generated by one or both of set of rules 190 stored in memory unit 124 and artificial intelligence program 191 in the memory unit. In another embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007

In one embodiment, the WCD, using the POS function, is enabled to acquire identification data 192 of an item. In the discussion that follows, item 120 is used as an example, however, it should be understood that a different item could be used. The WCD is further arranged to acquire identification data 192 using any means known in the art. For example, the data can be acquired by camera 134 built into the device that takes pictures of barcodes or other identifying indicia on item 120 and converts the picture into the identification. In another embodiment, an end user can input data regarding the item using GUI 136 and the WCD converts the input into the identification data. Then, the marketing element is arranged to: receive, using the interface element, identification data 192 from the WCD via the communication network; generate marketing information 193 for item 120; and transmit, using the interface element, the marketing information to the communication network for transmission to the WCD.

In one embodiment, the offer element is arranged to generate the offer using at least one executable 194 generated by one or both of set of rules 196 stored in memory unit 124 and artificial intelligence program 198 in the memory unit. In another embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In a preferred embodiment, the WCD is arranged to suppress, using processor 106 or 132, a WCD function or the POS function. The WCD function can be any function known in the art, for example, transceiving a telephone call or transceiving text messages or data. Thus, when a call or other function becomes available on the WCD during a POS order, for example, the WCD receives a telephone call, the WCD or computer 108 is configured to handle the function at least in the following manner: the WCD function can occur simultaneously on the WCD with the POS function; the WCD function can be suppressed while enabling the POS function; or the POS function can be suppressed while enabling the WCD function. Either of both the WCD and computer 108 can be configured to select preferences for handling WCD functions during a POS function session.

In one embodiment, the WCD can be used to modify order 122. For example, the WCD transmits change signal 199, through network 116 to the interface element. The change signal includes instructions to remove an item from order 122 or to otherwise modify order 122. The order item receives the change signal and modifies the order accordingly. The change signal can be generated as described for data 119.

It should be understood that the sets of rules can be combined in a single set of rules (not shown) or that the artificial intelligence programs can be combined in a single program (not shown).

It should be understood that various storage and removal operations, not explicitly described above, involving memory elements 124 and/or 132 are possible, as known in the art, with respect to the operation of system 100. For example, outputs from and inputs to the general-purpose computer and/or the WCD can be stored and retrieved from the respective memory elements.

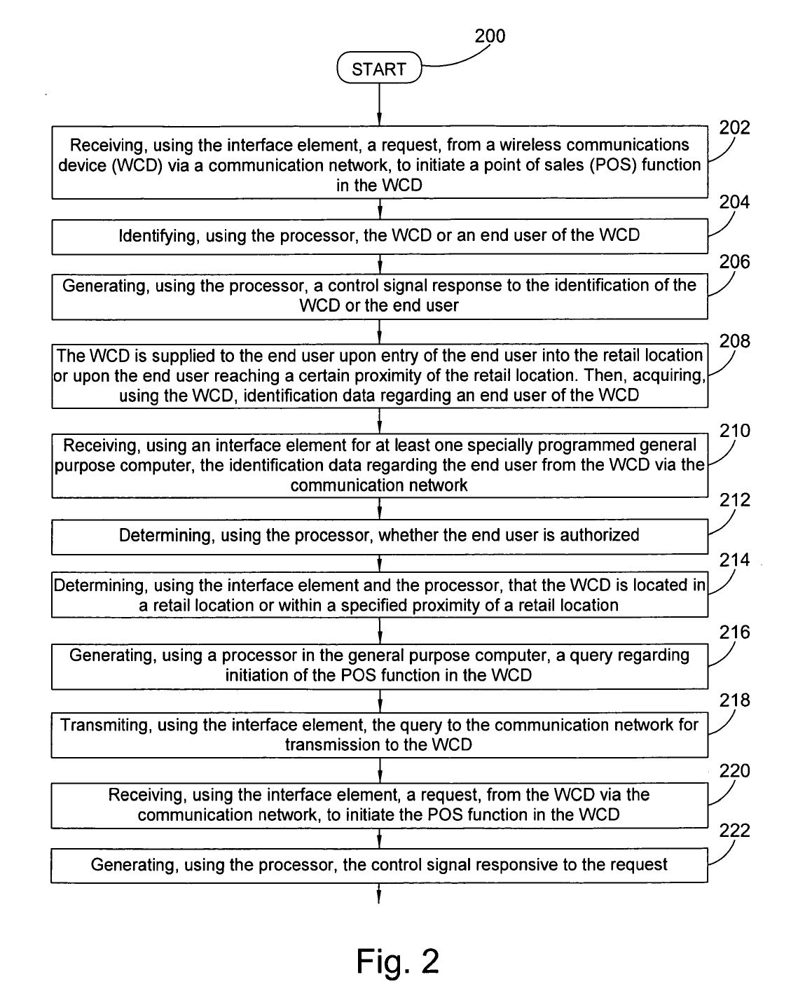

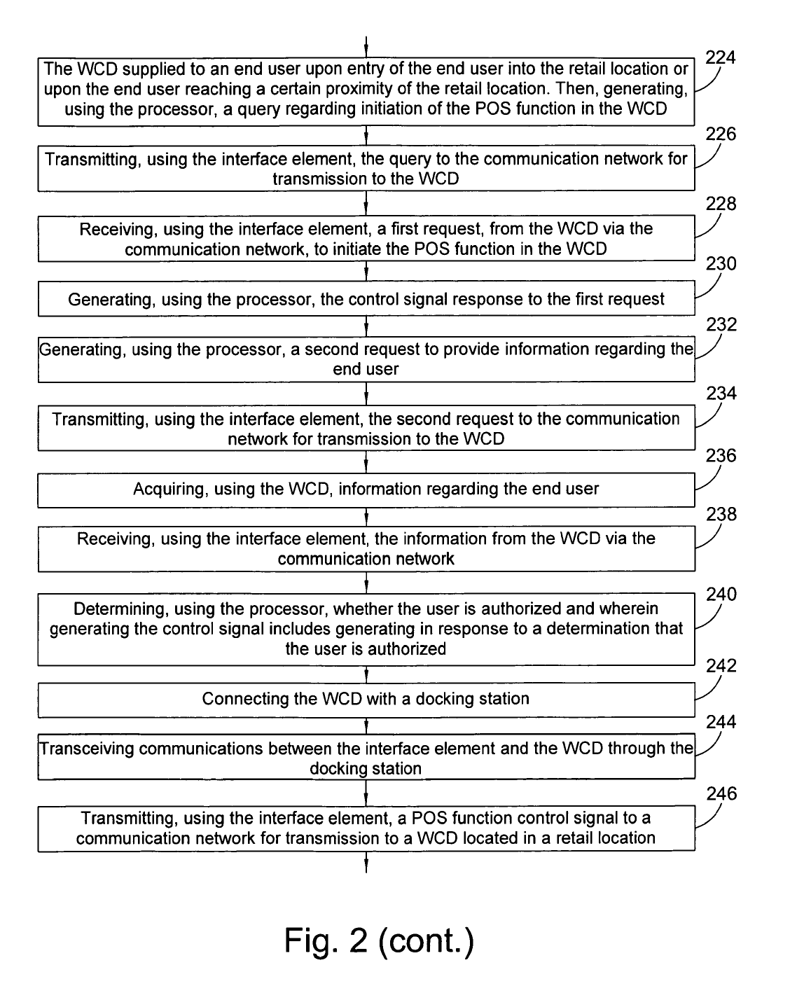

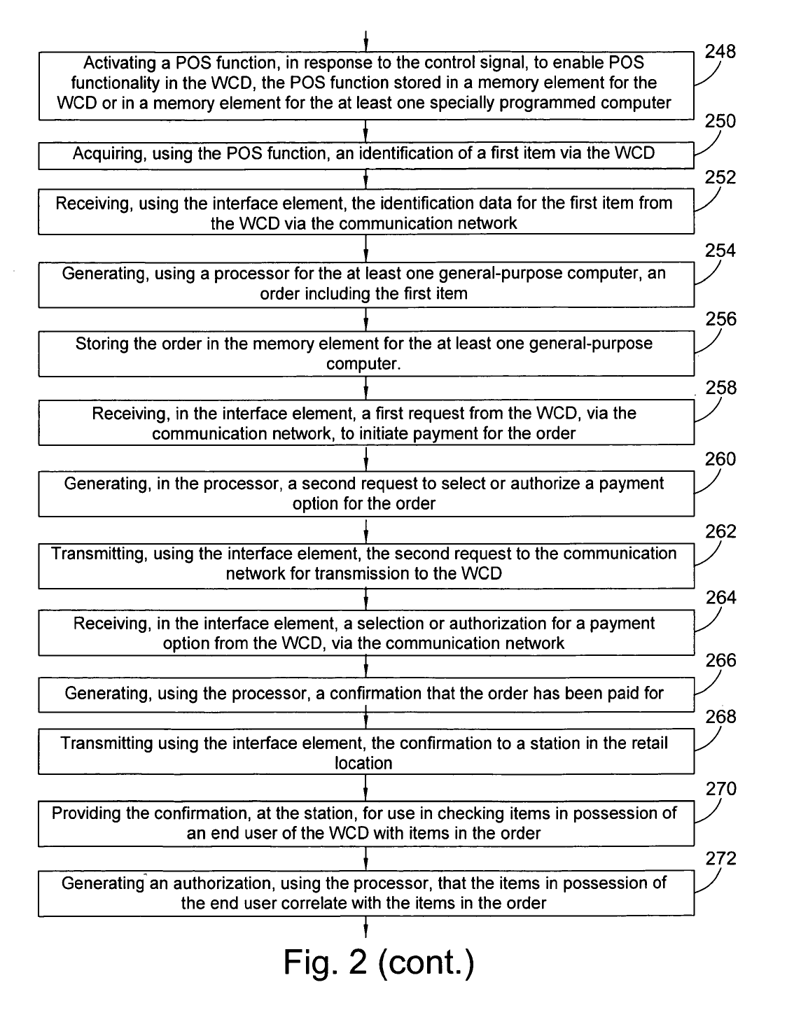

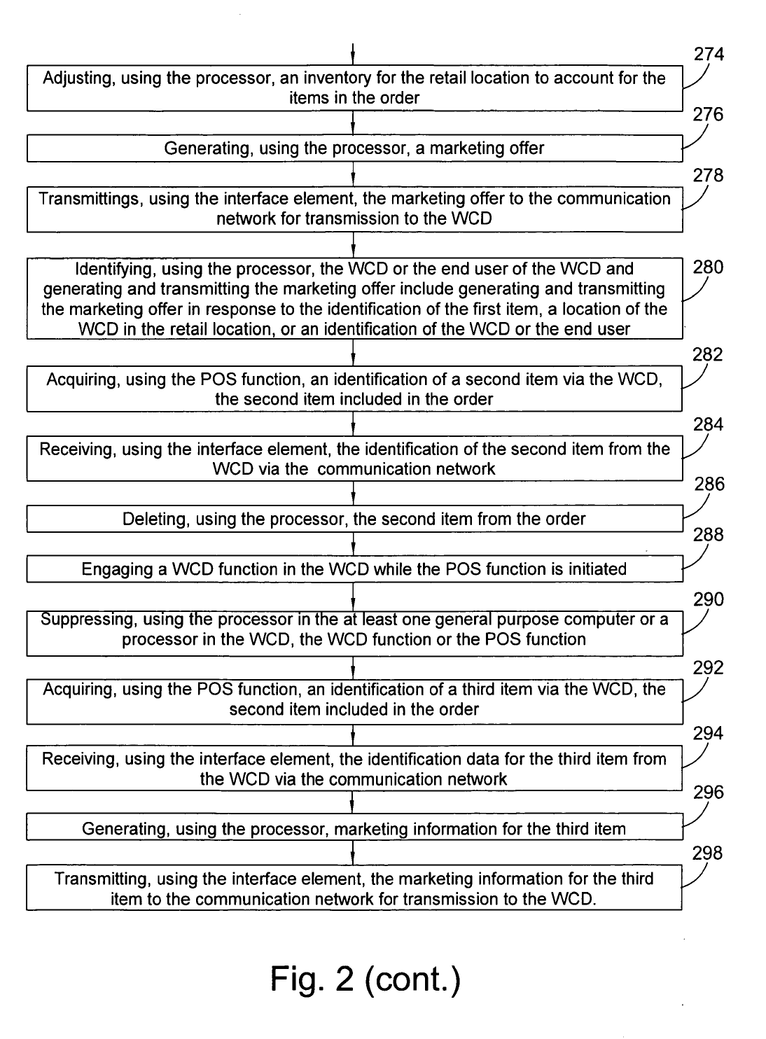

FIG. 2 is a flow chart illustrating a present invention method for enabling POS functionality in a WCD. Although the method in FIG. 2 is depicted as a sequence of numbered steps for clarity, no order should be inferred from the numbering unless explicitly stated. The method starts at Step 200. Step 246 transmits, using an interface element in at least one specially programmed general purpose computer, a POS function control signal to a communication network for transmission to a WCD, the WCD located in a retail location. Step 248 activates a POS function, in response to the control signal, to enable POS functionality in the WCD, the POS function stored in a memory element for the WCD or in a memory element for the at least one specially programmed computer. Step 250 acquires, using the POS function, an identification of a first item via the WCD. Step 252 receives, using the interface element, the identification data for the first item from the WCD via the communication network. Step 254 generates, using a processor for the at least one general-purpose computer, an order including the first item. Step 256 stores the order in the memory element for the at least one general-purpose computer.

In a preferred embodiment step 202 receives, using the interface element, a request, from the WCD via the communication network, to initiate the POS function in the WCD; step 204 identifies, using the processor, the WCD or an end user of the WCD; and step 206 generates, using the processor, the control signal response to the identification of the WCD or the end user.

In a first embodiment, the WCD supplied to the end user upon entry of the end user into the retail location or upon the end user reaching a certain proximity of the retail location. Then, step 208 acquires, using the WCD, identification data regarding an end user of the WCD; step 210 receives, using the interface element, the identification data regarding the end user from the WCD via the communication network; and step 212 determines, using the processor, whether the end user is authorized. Then, generating and transmitting the control signal to the communication network for transmission to the WCD includes generating and transmitting in response to a determination that the user is authorized.

In a second embodiment, step 214 determines, using the interface element and the processor, that the WCD is located in the retail location or within a specified proximity of the retail location; step 216 generates, using the processor, a query regarding initiation of the POS function in the WCD; step 218 transmits, using the interface element, the query to the communication network for transmission to the WCD; step 220 receives, using the interface element, a request, from the WCD via the communication network, to initiate the POS function in the WCD; and step 222 generates, using the processor, the control signal responsive to the request.

In a third embodiment, the WCD supplied to an end user upon entry of the end user into the retail location or upon the end user reaching a certain proximity of the retail location. Then, step 224 generates, using the processor, a query regarding initiation of the POS function in the WCD; step 226 transmits, using the interface element, the query to the communication network for transmission to the WCD; step 228 receives, using the interface element, a first request, from the WCD via the communication network, to initiate the POS function in the WCD; step 230 generates, using the processor, the control signal response to the first request; step 232 generates, using the processor, a second request to provide information regarding the end user; step 234 transmits, using the interface element, the second request to the communication network for transmission to the WCD; step 236 acquires, using the WCD, information regarding the end user; step 238 receives, using the interface element, the information from the WCD via the communication network; and step 240 determines, using the processor, whether the user is authorized and wherein generating the control signal includes generating in response to a determination that the user is authorized.

In a fourth embodiment, step 242 connects the WCD with a docking station and step 244 transceives communications between the interface element and the WCD through the docking station. In a preferred embodiment, step 258 receives, in the interface element, a first request from the WCD, via the communication network, to initiate payment for the order; step 260 generates, in the processor, a second request to select or authorize a payment option for the order; step 262 transmits, using the interface element, the second request to the communication network for transmission to the WCD; and step 264 receives, in the interface element, a selection or authorization for a payment option from the WCD, via the communication network. In one embodiment, step 266 generates, using the processor, a confirmation that the order has been paid for; step 268 transmits, using the interface element, the confirmation to a station in the retail location; step 270 provides the confirmation, at the station, for use in checking items in possession of an end user of the WCD with items in the order; and step 272 generates an authorization, using the processor, that the items in possession of the end user correlate with the items in the order.

In a fifth embodiment, step 274 adjusts, using the processor, an inventory for the retail location to account for the items in the order. In a sixth embodiment, step 276 generates, using the processor, a marketing offer; and step 278 transmits, using the interface element, the marketing offer to the communication network for transmission to the WCD. In a seventh embodiment, step 280 identifies, using the processor, the WCD or the end user of the WCD and generating and transmitting the marketing offer include generating and transmitting the marketing offer in response to the identification of the first item, a location of the WCD in the retail location, or an identification of the WCD or the end user.

In an eighth embodiment, step 282 acquires, using the POS function, an identification of a second item via the WCD, the second item included in the order; step 284 receives, using the interface element, the identification of the second item from the WCD via the communication network; and step 286 deletes, using the processor, the second item from the order. In a preferred embodiment, step 288 engages a WCD function in the WCD while the POS function is initiated; and step 290 suppresses, using the processor in the at least one general purpose computer or a processor in the WCD, the WCD function or the POS function.

In a ninth embodiment, step 292 acquires, using the POS function, an identification of a third item via the WCD, the second item included in the order; step 294 receives, using the interface element, the identification data for the third item from the WCD via the communication network; step 296 generates, using the processor, marketing information for the third item; and step 298 transmits, using the interface element, the marketing information for the third item to the communication network for transmission to the WCD.

The following is a listing of exemplary tables that can be used in a present invention method or system. It should be understood that a present invention method or system is not limited to any or all of the tables shown and that other tables are included in the spirit and scope of the claimed invention.

The following is a further listing of exemplary data bases that can be used in a present invention method or system. It should be understood that a present invention method or system is not limited to any or all of the databases shown and that other databases are included in the spirit and scope of the claimed invention.

Central System

Customer database

Customer purchase history

Customer billing information

Customer personal information

End user device ID 1-n

Customer ID

Item Database

Item ID

Item Price 1-n

Item Price rules 1-n

Quantity

Transaction/Order Database

Item ID 1-n

Customer ID 1-n

Order Status

Promotions offered 1-n

Promotions accepted 1-n

Order total

Discounts 1-n

Promotional Database

Promotion ID

Promotion Rules

Function Rules Database

Function ID

End User Device ID

Function Rules 1-n

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A wireless communication device, comprising:
a processor; and
a memory storing instructions that when executed by the processor result in:
automatically sending a request, based on position information of the wireless communication device and to a system via a cellular telephone network, to initiate a POS function on the wireless communication device;
receiving, from the system and via the cellular telephone network, and in response to the request, a POS control signal that activates the POS function on the wireless communication device;
acquiring, by a camera of the wireless communication device, information identifying an item in a retail location; and
transmitting, to the system and via the cellular telephone network, the information identifying the item in the retail location and a request to purchase the item utilizing an account of a user of the wireless communication device.

2. The wireless communication device of claim 1, wherein the memory stores instruction that when executed by the processor further result in:
receiving, from the system and via the cellular telephone network, a confirmation of a purchase of the item.

3. The wireless communication device of claim 1, wherein the position information of the wireless device upon which the automatic sending of the request is based comprises a geographic location of the wireless device.

4. The wireless communication device of claim 1, wherein the system is different than a POS system of the retail location.

5. The wireless communication device of claim 1, wherein the acquiring, by the camera of the wireless communication device, of the information identifying the item in the retail location, comprises:
taking a picture of an indicia identifying the item; and
converting the picture into the information identifying the item.

6. The wireless communication device of claim 1, wherein the transmitting of the request to purchase the item utilizing the account of the user of the wireless communication device comprises an authorization to charge a digital wallet of the user.

7. The wireless communication device of claim 1, wherein the wireless communication device comprises a cellular telephone owned by the user and wherein the instructions stored in the memory comprise a POS application.

8. A method, comprising:
automatically sending a request, by a processing device and based on position information of a wireless communication device and to a system via a cellular telephone network, to initiate a POS function on the wireless communication device;
receiving, by the processing device and from the system and via the cellular telephone network, and in response to the request, a POS control signal that activates the POS function on the wireless communication device;
acquiring, by a camera of the wireless communication device, information identifying an item in a retail location; and
transmitting, by the processing device and to the system and via the cellular telephone network, the information identifying the item in the retail location and a request to purchase the item utilizing an account of a user of the wireless communication device.

9. The method of claim 8, further comprising:
receiving, from the system and via the cellular telephone network, a confirmation of a purchase of the item.

10. The method of claim 8, wherein the position information of the wireless device upon which the automatic sending of the request is based comprises a geographic location of the wireless device.

11. The method of claim 8, wherein the system is different than a POS system of the retail location.

12. The method of claim 8, wherein the acquiring, by the camera of the wireless communication device, of the information identifying the item in the retail location, comprises:
taking a picture of an indicia identifying the item; and
converting the picture into the information identifying the item.

13. The method of claim 8, wherein the transmitting of the request to purchase the item utilizing the account of the user of the wireless communication device comprises an authorization to charge a digital wallet of the user.

14. The method of claim 8, wherein the wireless communication device comprises a cellular telephone owned by the user and wherein the method is executed based on stored instructions defining a POS application.

15. A non-transitory computer-readable medium storing instructions that when executed by a processing device result in:
automatically sending a request, based on position information of a wireless communication device and to a system via a cellular telephone network, to initiate a POS function on the wireless communication device;
receiving, from the system and via the cellular telephone network, and in response to the request, a POS control signal that activates the POS function on the wireless communication device;
acquiring, by a camera of the wireless communication device, information identifying an item in a retail location; and
transmitting, to the system and via the cellular telephone network, the information identifying the item in the retail location and a request to purchase the item utilizing an account of a user of the wireless communication device.

16. The non-transitory computer-readable medium of claim 15, wherein the instructions, when executed by the processing device, further result in:
receiving, from the system and via the cellular telephone network, a confirmation of a purchase of the item.

17. The non-transitory computer-readable medium of claim 15, wherein the position information of the wireless device upon which the automatic sending of the request is based comprises a geographic location of the wireless device.

18. The non-transitory computer-readable medium of claim 15, wherein the system is different than a POS system of the retail location.

19. The non-transitory computer-readable medium of claim 15, wherein the acquiring, by the camera of the wireless communication device, of the information identifying the item in the retail location, comprises:
taking a picture of an indicia identifying the item; and
converting the picture into the information identifying the item.

20. The non-transitory computer-readable medium of claim 15, wherein the wireless communication device comprises a cellular telephone owned by the user and wherein the stored instructions define a POS application.
